(19) United States
(12) Patent Application Publication
(10) Pub. No.: US 2002/0048386 A1
(43) Pub. Date: Apr. 25, 2002

(54) High definition transducer

(76) Inventors: Claude Annie Perrichon, L'Isle d'Abeau (FR); Pierre Piccaluga, L'Isle d'Abeau (FR); Patrice Morchain, Cambrai (FR); Marc Charbonneaux, Lyon (FR)

Correspondence Address: DARBY & DARBY, P.C., 805 Third Avenue, New York, NY, 10022, US

(21) Appl. No.: 10/016,824

(22) Filed: Dec. 3, 2001

(30) Foreign Application Priority Data
May 22, 2000 (FR) PCT/FR00/01397
Jun. 4, 1999 (FR) 99/07232

(51) Int. Cl. H04R 25/00

(52) U.S. Cl. 381/396; 381/191; 381/162

(57) ABSTRACT

A high definition electro-acoustic transducer is made up of at least one solenoid coiled on a rod, with the solenoid linked and electronically mounted in series or in parallel from any part of the audio electrical circuit. The pre-oriented particles of the ambient air undergo de-polarizations caused by the solenoid, which creates sounds. The impedance is adapted by an expert in the field, for example two or ten ohms, and the device, a fixed motor with rotating field, is an acoustic complement for all fields of audio and AV, acting in the ambient space, without using collisions of particles via a membrane, and giving an excellent acoustic reproductive finesse.

### BACKGROUND OF THE INVENTION

The present invention relates knowledge of membrane transducers does not impart distinction to all aspects of musical quality. The speed of movement is too slow, due to the inertia of the coil membrane mass.

As sound is the result of collisions of particles in the structure of the material, it is more appropriate to operate directly on air particles without using collisions via a membrane, especially for the upper part of the sound spectrum. This present procedure uses the earth's natural reference constant electromagnetic field, or a neighboring electromagnetic field, for example a magnet of medium strength. This imposed constant electromagnetic field orients the particles in space, either naturally or artificially. In this field, we superimpose at least one electromagnetic field which is variable according to the rhythm of an audio modulation. The particles pre-oriented by the reference constant electromagnetic field, undergo de-polarizations by the variable rotating electromagnetic field, and this procedure forces the air particles to agitate in the different orientations of the variable electromagnetic fields, which creates sounds due to the collision of particles induced to move. The present procedure indicates that with each variable electromagnetic field there is an association of a type of particle de-polarization: if there are several electromagnetic fields, there are several types of de-polarization. This procedure is a fixed motor with a rotating field used to activate the air de-polarization. This procedure is a fixed motor with a rotating field used to activate the air particles, a basic embodiment consists of at least one primary, solenoid coil, wound for example on a circle or rod, linked to an electric audio signal, a small magnet placed in the rod can act as a reference electromagnetic field. The device on each primary coil can receive at least one secondary coil wound on the primary coil, which forms an electro-acoustic transformer through the addition of induced electromagnetic fields.

The device can be mounted in any portion of the audio electric circuit on an electro-acoustic speaker or the power circuit of an acoustic speaker.

The device can be linked and mounted electrically in series or in parallel, with impedance needing to be adapted by a person skilled in the art in order to achieve the desired effect. The device needs to be active within the listening space, in communication with the ambient air, without being isolated by a sealed product isolating it from the ambient space.

### BRIEF DESCRIPTION OF THE DRAWING FIGURES

FIG. 1 illustrates an embodiment of an electrostatic transducer in accordance with the present invention.

### DETAILED DESCRIPTION OF THE PREFERRED EMBODIMENT

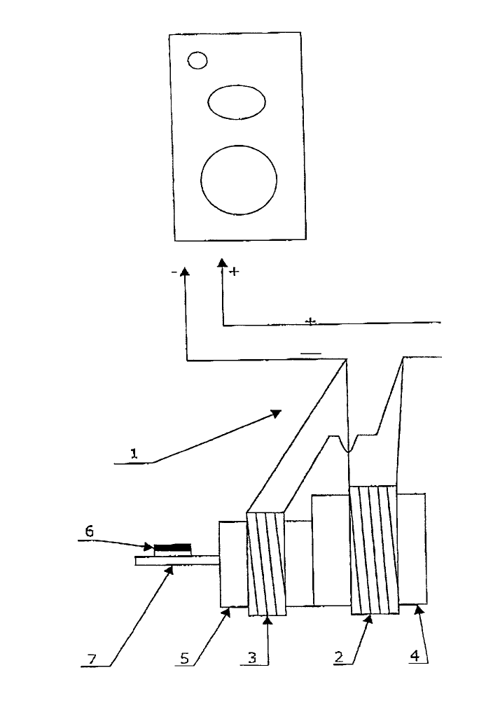

With reference to the attached drawing FIG. 1, an electrostatic transducer with a fixed motor and a variable field, made up of two primary coils (2, 3) mounted in parallel with four and two ohms on two rods (4, 5) of different diameters linked together. The small diameter receives a small magnet (6) two centimeters long and a section of one centimeter on the side. The magnet can slide into an elastic groove (7) and can be set at the optimum setting for acoustic performance, with the density of the reference electromagnetic field thus being perfectly adjusted. This high definition electro-acoustic transducer is serial mounted in series (1) on the negative pole power cable of an acoustic speaker, a non-imitative example of the present procedure created by a person skilled in the art. Sound reproduction is complete in all sound and speed expressions.

Parallel mounting with an appropriate impedance of for example eight or ten ohms and another device serial mounted like the one presented here, provide excellent finesse and reproduction.

The use of this acoustic transducer means that it is possible to suppress acoustic filter components either partially or totally, as the fixed motor is also a transformer by virtue of also being a self-induction coil, with effective sound performance. The device and procedure are an acoustic complement to sound reproduction in all audio and audio-visual fields.

What is claimed is:

1. A procedure for sound reproduction, which operates directly on the particles in the ambient air without using collisions via a membrane, but via at least one electromagnetic field which is variable according to the rhythm of an audio modulation which forces the ambient air particles to move, which creates sounds through the air particles being set in motion, having been pro-oriented in a constant electromagnetic field by the constant electromagnetic field of the earth, this fixed motor procedure with ambient air particles in a rotating field, is an acoustic complement for all fields of audio and AV.

2. A procedure according to claim 1, characterized by the constant electromagnetic field orienting the particles artificially, the density of the reference electromagnetic field being thereby perfectly adjusted.

3. A device for sound reproduction being a high definition electro-acoustic transducer made up of at least one solenoid coiled on a rod, with the solenoid linked and electronically mounted in series or in parallel from any part of the audio electrical circuit, the pre-oriented particles of the ambient air undergo de-polarizations caused by the solenoid, which creates sounds, the impedance is adapted by an expert in the field, for example two or ten ohms, and the device, a fixed motor with rotating field, is an acoustic complement for all fields of audio and AV, acting in the ambient space, without using collisions of particles via a membrane, and giving an excellent acoustic reproductive finesse.

4. A device according to claim 3, characterized by the fact that the coil solenoid may receive at least a secondary, which constitutes an electro-acoustic transformer through the addition of variable electromagnetic fields.

5. A device according to claim 3, wherein by a constant electromagnetic field, with a small magnet can slide into an elastic groove, so that it can be set at the optimum adjustment for acoustical performance.

6. A device according to claim 4, wherein by a constant electromagnetic field, with a small magnet can slide into an elastic groove, so that it can be set at the optimum adjustment for acoustical performance.

7. A device according to claim 3, characterized by the fact that it is a self-induction coil enabling self-induction coil and acoustic filter components to be suppressed.

8. A device according to claim 4, characterized by the fact that it is a self-induction coil enabling self-induction coil and acoustic filter components to be suppressed.

9. A device according to claim 5, characterized by the fact that it is a self-induction coil enabling self-induction coil and acoustic filter components to be suppressed.

10. A device according to claim 6, characterized by the fact that it is a self-induction coil enabling self-induction coil and acoustic filter components to be suppressed.
